(19) United States
(12) Patent Application Publication
(10) Pub. No.: US 2026/0316306 A1
(43) Pub. Date: Oct. 15, 2026

(54) SWAPPABLE BATTERY SYSTEMS FOR MOBILE ROBOTS

(71) Applicant: happy droid, inc., San Mateo, CA (US)

(72) Inventors: Sinan Filiz, San Mateo, CA (US); Ian James Edwin Smith, San Jose, CA (US)

(21) Appl. No.: 19/358,046

(22) Filed: Oct. 14, 2025

Related U.S. Application Data
(60) Provisional application No. 63/707,331, filed on Oct. 15, 2024.

(51) Int. Cl. B25J 19/00; B25J 5/00; B25J 9/16; H01M 10/48; H02J 7/34; H02J 7/82

(52) U.S. Cl. CPC B25J 19/005; B25J 5/007; B25J 9/1679; H01M 10/482; H02J 7/342; H02J 7/82

(57) ABSTRACT

Systems and methods for a mobile robot having a swappable battery are disclosed herein. A mobile robot can include a robot body having at least one component for movement of the mobile robot, a manipulator configured to manipulate an environment external to the mobile robot, one or more swappable batteries releasably coupled to the mobile robot, the one or more swappable batteries configured to provide electrical power for operation of the mobile robot, and one or more non-transitory memories storing computing instructions configured to communicate with one or more processors and cause the one or more processors to move the mobile robot by the component for movement of the mobile robot and to manipulate, by the manipulator, the one or more swappable batteries.

### CROSS-REFERENCE TO RELATED APPLICATIONS

This application claims priority and the benefit of U.S. Provisional Patent Application No. 63/707,331 filed on Oct. 15, 2024 entitled “SWAPPABLE BATTERY SYSTEMS FOR MOBILE ROBOTS.” The disclosure of the foregoing application is incorporated herein by reference, except for any subject matter disclaimers or disavowals, and except to the extent of any conflict with the disclosure of the present application, in which case the disclosure of the present application shall control.

### TECHNICAL FIELD

The present disclosure relates to mobile robots, and more particularly, to self-swappable battery systems therefor to ensure uninterrupted operation.

### BACKGROUND

Mobile robots are desirable for performing a wide variety of tasks. Typically, mobile robots are operative on battery power, and require downtime in a fixed location for battery charging when the batteries are depleted. Accordingly, improved systems and methods remain desirable.

### SUMMARY

Various embodiments of the present disclosure relate to mobile robots having swappable batteries, for example hot-swappable batteries. While the ways in which various embodiments of the present disclosure address drawbacks of prior systems and methods are discussed in more detail below, in general, exemplary embodiments of the disclosure provide improved systems and methods for hot swapping a battery of a mobile robot without loss of power to the mobile robot. Exemplary methods provide desired retention of runtime settings and capability for a mobile robot to replace its own depleted batteries without the assistance of a human operator and/or an external robotic manipulator.

In accordance with various embodiments of the disclosure, a mobile robot having a swappable battery is disclosed herein. The mobile robot can include a robot body having at least one component for movement of the mobile robot, a manipulator configured to manipulate an environment external to the mobile robot, one or more swappable batteries releasably coupled to the mobile robot, the one or more swappable batteries configured to provide electrical power for operation of the mobile robot, and one or more non-transitory memories storing computing instructions configured to communicate with one or more processors and cause the one or more processors to move the mobile robot by the component for movement of the mobile robot and to manipulate, by the manipulator, the one or more swappable batteries.

In various embodiments, the mobile robot can include two or more batteries, and at least one of the two or more batteries can be of the one or more swappable batteries. At least one of the two or more batteries can be a fixed battery. The mobile robot can further include a first ideal diode controller electrically coupled between a first of the two or more batteries and at least one of the component for movement of the mobile robot, the manipulator, and the one or more processors. The mobile robot can further include a second ideal diode controller electrically coupled between a second of the two or more batteries and at least one of the component for movement of the mobile robot, the manipulator, and the one or more processors. The mobile robot can further include a hot-swap controller electrically coupled between each of the first ideal diode controller and the second ideal diode controller and at least one of the component for movement of the mobile robot, the manipulator, and the one or more processors.

In various embodiments, the component for movement can include a plurality of legs, a plurality of wheels, or a combination thereof. The manipulator can include a robotic arm. The robotic arm can include a grasping apparatus configured to grasp a depleted battery from the one or more swappable batteries. The robotic arm can be operable to decouple the depleted battery from the mobile robot. The one or more non-transitory memories can store further computing instructions configured to communicate with the one or more processors and which can further cause the one or more processors to cause the robotic arm to decouple a depleted battery from the mobile robot, to grasp a charged battery an external environment, and to couple the charged battery to the mobile robot. The charged battery can be configured to provide electrical power for operation of the mobile robot.

In accordance with various embodiments of the disclosure, a system for mobile robots having swappable batteries is disclosed herein. The system can include one or more mobile robots. Each of the one or more mobile robots can include a robot body having at least one component for movement of the mobile robot, one or more swappable batteries releasably coupled to the mobile robot, the swappable batteries configured to provide electrical power for operation of the mobile robot, and one or more non-transitory memories storing computing instructions configured to communicate with one or more processors and cause the one or more processors to move the mobile robot by the component for movement of the mobile robot. The system can include a charging station configured to charge the one or more swappable batteries. The charging station can include a manipulator configured to manipulate the one or more swappable batteries.

In various embodiments, the manipulator can be configured to decouple a depleted battery of the one or more swappable batteries from a mobile robot of the one or more mobile robots and to couple the depleted battery to the charging station to recharge the depleted battery. The manipulator can be configured to decouple a charged battery from the charging station and to couple the charged battery to a mobile robot of the one or more mobile robots. The charged battery configured to provide electrical power for operation of the mobile robot.

In accordance with various embodiments of the disclosure, a method of hot-swapping one or more swappable batteries for a mobile robot comprising two or more batteries is disclosed herein. The method can include electrically disconnecting, by a first ideal diode controller, a first of the two or more batteries from the mobile robot, maintaining, by a second ideal diode controller, an electrical connection between a second of the two or more batteries and the mobile robot, decoupling, by a manipulator, the first of the two or more batteries from the mobile robot, coupling, by the manipulator, a third battery to the mobile robot, and electrically connecting, by the first ideal diode controller, the third battery to the mobile robot.

In various embodiments, the first of the two or more batteries and the second of the two or more batteries can be swappable. The method can further include detecting, by the mobile robot, that the first of the two or more batteries is below a threshold state of charge. The method can further include detecting a voltage (i.e., of the first battery and/or the third battery) after the step of decoupling the first battery to the mobile robot and before the step of coupling the third battery to the mobile robot. The detecting the voltage may indicate the coupling status of the first battery to the mobile robot. The method can further include detecting, by the mobile robot, that a voltage received from the third battery is above a threshold level. The detecting the voltage can be after the step of coupling the third battery to the mobile robot and before the step of electrically connecting the third battery to the mobile robot.

In various embodiments, the second of the two or more batteries can be a fixed battery. The method can further include electrically connecting, by the second ideal diode controller, the second of the two or more batteries to the mobile robot before electrically disconnecting the first of the two or more batteries from the mobile robot. The method can further include electrically disconnecting, by the second ideal diode controller, the second of the two or more batteries from the mobile robot after electrically connecting the third battery to the mobile robot and recharging, by the third battery, the second of the two or more batteries.

These and other embodiments will become readily apparent to those skilled in the art from the following detailed description of certain embodiments having reference to the attached figures; the invention not being limited to any particular embodiment(s) disclosed. This section is intended as a simplified introduction to the disclosure, and is not intended to limit the scope of any claim.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates a block diagram of aspects of a swappable battery system for a mobile robot, in accordance with various embodiments;

FIG. 2 illustrates an ideal diode controller, in accordance with various embodiments;

FIG. 3 illustrates an exemplary power architecture for a swappable battery system, in accordance with various embodiments;

FIG. 4 illustrates a block diagram of a method for swapping a battery in a mobile robot, in accordance with various embodiments;

FIG. 5 illustrates a block diagram of a method for swapping a battery in a mobile robot with two or more swappable batteries, in accordance with various embodiments; and

FIG. 6 illustrates a block diagram of a method for swapping a battery in a mobile robot with a fixed battery, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, electrical, and/or mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”) and/or a radio frequency (RF) communications protocol. In this regard, “electronic communication,” as used herein, includes wired and wireless communications (e.g., Bluetooth, Bluetooth LE, NFC, TCP/IP, Wi-Fi, etc.).

In the context of the present disclosure, methods, systems, and articles may find particular use in connection with mobile robots, such as humanoid robots, quadruped robots, wheeled robots, and/or the like. However, various aspects of the disclosed embodiments may be adapted for performance in a variety of other systems. Accordingly, numerous applications of the present disclosure may be realized.

In various embodiments, examples of a mobile robot can be a general purpose humanoid robot, a quadruped robot, or a home maintenance robot with arms and wheels. A mobile robot that is equipped with only a fixed (non-swappable) battery would need to wait at a charging station while the battery is being charged, or must be tethered to a charging cable during charging, both of which are limiting to the functionality of the robot. There can be a wireless or a contact based charging system to allow the robot to be mobile during charging, however these advanced systems have significant drawbacks such as difficulty in implementation, safety risks, as well as high cost and complexity.

In contrast, in accordance with principles of the present disclosure, swappable batteries can be used to keep mobile robots operational with minimal and/or eliminated downtime for charging. One or more depleted batteries of the robot may be swapped with previously charged replacement batteries (i.e., of a same or similar type). In various embodiments, one or more swappable batteries may be hot-swapped (e.g., the swappable batteries may be swapped without the mobile robot being powered off), which may allow the mobile robot to retain any runtime settings in place, calibration settings, and may allow the mobile robot to swap its own batteries without the assistance of an external swapping mechanism (i.e., a person, an external manipulator, or another robot).

In the present disclosure, innovative concepts regarding several categories of swappable battery implementation scenarios are presented. In various exemplary embodiments, mobile robot battery options can include, but are not limited to, (A) one swappable battery only; (B) two (or more) swappable batteries; or (C) one (or more) swappable battery and one (or more) fixed battery. A battery swap operation can be performed by a person, by a battery charging station manipulator, by the mobile robot itself (i.e., using a manipulator), and/or by a robot for another mobile robot.

For scenario (B) above, the description above and the remainder of the present disclosure may use “two swappable batteries” or similar statements for simplicity; however, a mobile robot can have more than two swappable batteries. For example, a mobile robot can have three, four, or more swappable batteries, for example, if desired in connection with a product advantage. Moreover, the swappable batteries may be similar or identical, or may differ from one another in size, form factor, chemistry, capacity, or other aspects. Any suitable battery may be used.

Likewise, for scenario (C) above, the description above and the remainder of this disclosure may use “one swappable and one fixed battery” or similar statements for simplicity; however, a robot can have more batteries. For example, a robot can have two, three, or more swappable batteries and/or two, three, or more fixed/non-swappable batteries, for example if there is a product advantage. Again, the swappable batteries and the fixed batteries may be similar or identical, or may differ from one another in size, form factor, chemistry, capacity, or other aspects.

In various exemplary embodiments, in scenario (A) a mobile robot may have (e.g., only) one swappable battery. Advantages of scenario (A) over scenarios (B) and (C) may include lower product cost, complexity, and weight. However, the mobile robot may be powered down (or connected to a fixed external power source) during battery swapping because there is a single battery.

In a scenario A1, a mobile robot may have one swappable battery only and a person may swap the battery. This is a simple option to implement within this category; however, this approach requires a person to be available for the task.

In a scenario A2, a mobile robot may have one swappable battery only and a charging station may swap the battery, for example by a manipulator. An arm or a manipulator on the charging station may remove the swappable battery from the mobile robot and may install a previously charged battery from the charging station on the mobile robot. In this manner, there is no need for a person to perform the swapping operation. Scenario A2 can be further optimized for a faster battery swap by having multiple arms or manipulators and multiple charging slots on the charging station. A charging station can include any suitable number of charging slots and any suitable number of arms and/or manipulators. Thus, for example, a charging station may service multiple mobile robots, for example two mobile robots, three mobile robots, five mobile robots, ten mobile robots, and so forth, at the same time or at overlapping times.

In a scenario A3, a mobile robot may have one swappable battery only and the mobile robot may swap its own battery. A mobile robot may use an arm or manipulator to connect itself to an external power source prior to performing the battery swap so that it does not lose power during the battery swap. The mobile robot may use the arm or manipulator to swap its own battery, for example with a previously charged battery of a charging station.

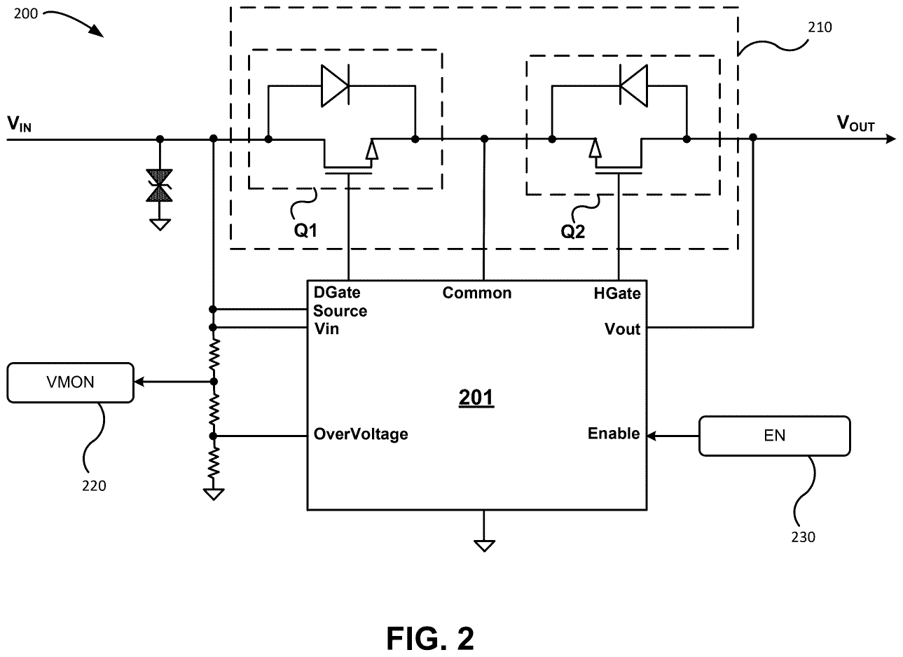

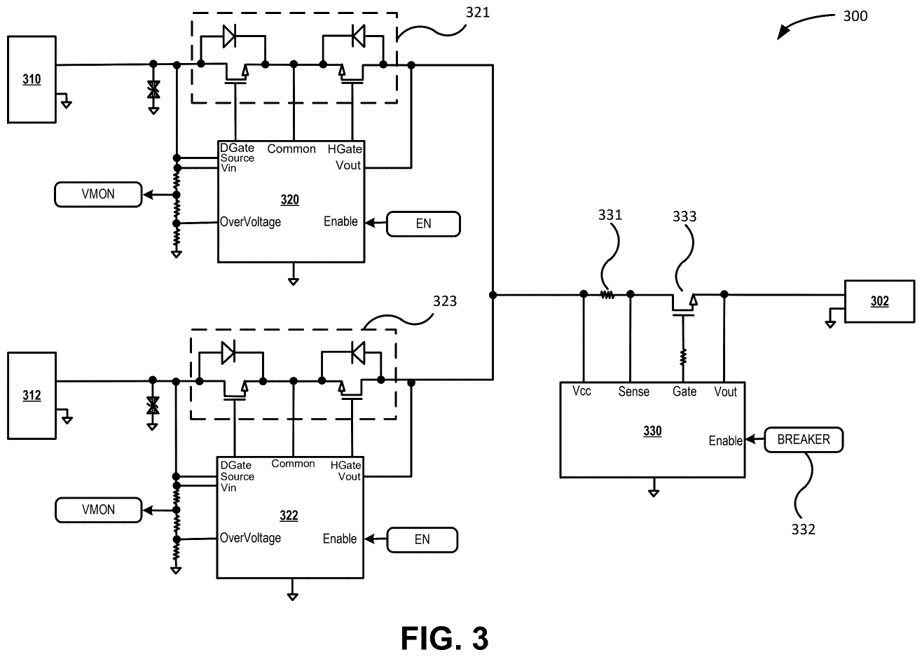

In various exemplary embodiments, in scenario (B) a mobile robot may have multiple swappable batteries. In this manner, the mobile robot does not need to shut down or connect to external power during battery swapping. The mobile robot may swap the batteries one at a time (e.g., sequentially and/or swapping only a subset of the mobile robot's batteries). In this manner, the mobile robot may remain powered and can swap its own battery, for example, in scenario B3 discussed below. The power architecture of the mobile robot, discussed in more detail below with respect to FIGS. 2 and 3, may allow the mobile robot to operate via a single battery, and may utilize additional batteries for added capacity. For example, a mobile robot may be configured to operate all external manipulators, sensors, computing and/or communications hardware, and/or the like, from the electrical current available from a single battery (i.e., during a battery swap).

In a scenario B1, a mobile robot may have multiple swappable batteries and a person may swap one or more of the swappable batteries. An advantage of this option over option A1 is one battery can be swapped at a time, and the robot wouldn't need to shut down or connect to external power during the swap to maintain runtime settings, calibration settings, or the like, as discussed above.

In a scenario B2, a mobile robot may have multiple swappable batteries and a charging station may swap the battery, for example by operation of a manipulator. In this manner, the mobile robot does not need to shut down or to connect to external power during swap, as in scenario B1, and further, there is no need for a person to perform the swapping operation. A charging station may service multiple mobile robots simultaneously or at overlapping times, as discussed above.

In a scenario B3, a mobile robot may have multiple swappable batteries and the mobile robot may swap its own battery. For example, the mobile robot may use an arm and/or manipulator to perform the battery swap. The mobile robot may swap one battery at a time and may be powered by the at least one other battery which remains connected during the battery swap. In this manner, a person is not needed to perform the swapping operation, and a charging station does not require an arm or manipulator.

In various exemplary embodiments, the mobile robot arm and/or manipulator ranges and capabilities as well as the battery's location on the robot are configured such that the mobile robot arm and/or manipulator can reach the battery (i.e., to be able to remove and replace it). For example, with respect to a humanoid robot, one or more batteries can be placed in the torso of the robot, such as in the chest and/or abdominal region, with access from the front so that the robot can swap them using its own arms. Batteries may be placed behind a lid or flexible cover, for example for dust or waterproofing. The mobile robot may open the lid, remove a depleted battery, install a charged battery, and close the lid.

In various exemplary embodiments, in scenario (C) a mobile robot may have one swappable and one fixed battery. The fixed battery may be relatively small compared to the swappable batteries. For example, the fixed battery may only be required to provide power to a mobile robot during a battery swap. In this manner, the capacity required of a fixed battery may be relatively low. The fixed battery may remain in the mobile robot (i.e., it is not swapped). A fixed battery may be less complex to implement and may utilize fewer parts and/or space on the mobile robot than a swappable battery. Further, a weight of the mobile robot may be reduced via implementation of a fixed battery, as a larger second swappable battery may optionally be eliminated. The swappable battery may be configured to charge the fixed battery, for example when a charge state of the fixed battery falls below a predetermined threshold.

In a scenario C1 a mobile robot may have one swappable and one fixed battery and a person may swap the battery. Such an approach may be desirable when a mobile robot cannot swap its own battery, for example due to the placement of the battery, not having sufficient manipulation range, another missing capability in its arm and/or manipulator or lack thereof. In such embodiments, the advantages of scenario (C) are still maintained. The mobile robot may remain powered during a battery swap, for example by the fixed battery, and a weight of the mobile robot may be reduced compared to scenario (B) employing multiple swappable batteries.

In a scenario C2 a mobile robot may have one swappable and one fixed battery and the charging station may swap the battery, for example by operation of a manipulator. In this manner, the mobile robot does not need to shut down or to connect to external power during swap, as in scenario C1, and further, there is no need for a person to perform the swapping operation. A charging station may service multiple mobile robots simultaneously or at overlapping times, as discussed above.

In a scenario C3 a mobile robot may have one swappable and one fixed battery and the robot may swap its own battery. In this manner, a mobile robot may swap its own battery/batteries, can remain powered during the battery swap, and may be implemented with less complexity, cost, and weight as compared to other approaches.

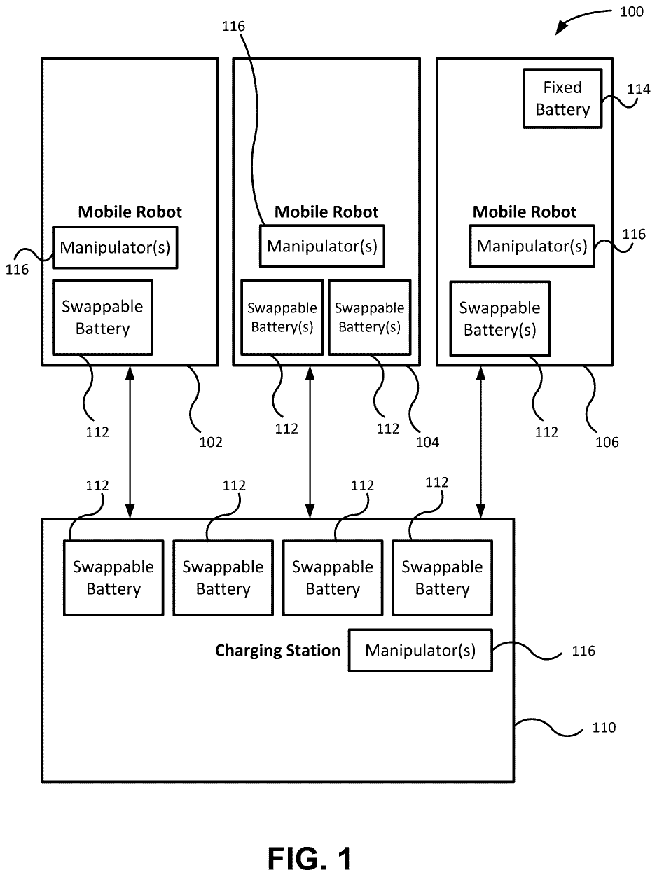

Turning now to the figures, FIG. 1 illustrates an exemplary block diagram of aspects of a swappable battery system 100 for a mobile robot. The system may include mobile robots 102, 104, 106. Mobile robot 102 may include a swappable battery 112 and optionally a manipulator 116. Mobile robot 102 may be suitable for use in Scenario (A), described in more detail above. Mobile robot 104 may include two or more swappable batteries 112 and optionally a manipulator 116. Mobile robot 104 may be suitable for use in Scenario (B), described in more detail above. Mobile robot 106 can include a swappable battery 112 and a fixed battery 114, and optionally a manipulator 116. Mobile robot 106 may be suitable for use in Scenario (C), described in more detail above. A manipulator 116 disposed on any of mobile robots 102, 104, 106 may be configured to remove a swappable battery 112 from the mobile robot 102, 104, 106, place the removed swappable battery 112 into a charging slot of a charging station to be charged (and/or otherwise couple or connect removed swappable battery 112 to the charging station), remove a previously charged swappable battery 112 from a charging slot of a charging station, and couple the previously charged swappable battery 112 to the mobile robot 102, 104, 106 to provide power to the mobile robot 102, 104, 106.

Swappable battery system 100 may include a charging station 110. Charging station 110 may include any suitable charging station configured to charge a swappable battery 112. Charging station 110 may include any suitable number of charging slots, for example, 1, 2, 3, 4, 5, 10, or more charging slots. Each charging slot may be configured to charge a swappable battery 112. Charging station 110 may optionally include one or more manipulators 116. A manipulator 116 disposed on a charging station 110 may be configured to remove a swappable battery 112 from a mobile robot 102, 104, 106, place the removed swappable battery 112 into a charging slot to be charged, remove a previously charged swappable battery 112 from a charging slot, and couple the previously charged swappable battery 112 to the mobile robot 102, 104, 106 to provide power to the mobile robot 102, 104, 106.

FIG. 2 illustrates an exemplary ideal diode control system 200, in accordance with various exemplary embodiments. The ideal diode control system 200 can include an ideal diode controller 201, back-to-back MOSFETs 210, a voltage monitor 220, and a battery enable input 230. An ideal diode control system may provide a low forward voltage drop, reverse polarity protection, reverse current protection, and fast reverse recovery to a power circuit within a mobile robot.

Ideal diode controller 201 can include a first gate drive DGate and a second gate drive HGate. The first gate drive can be configured to drive a first MOSFET Q1 (i.e., of the back-to-back MOSFETs 210) and the second gate driver can be configured to drive a second MOSFET Q2 (i.e., of the back-to-back MOSFETs 210). The ideal diode controller 201 can include a Vin channel configured to provide power to the ideal diode controller 201. The ideal diode controller can include a Vout channel configured to read an output voltage of the back-to-back MOSFETs 210, which may also be the source voltage of the second MOSFET Q2. The ideal diode controller 201 can include an Over Voltage channel configured to determine whether an input voltage of the back-to-back MOSFETs 210 exceeds a predetermined threshold. If the input voltage exceeds the predetermined threshold, the Over Voltage channel causes the ideal diode controller 201 to drive a MOSFET (i.e., MOSFET Q2) to disable an input battery. The ideal diode controller can include an enable channel configured to receive a battery enable input command. The ideal diode controller 201 can drive a MOSFET (i.e., MOSFET Q2) in response to the battery enable input command. The ideal diode controller 201 can include a Source channel configured to read the source voltage of the first MOSFET (i.e., MOSFET Q1). The Source channel may be connected to the Vin channel. The ideal diode controller 201 can include a common channel configured to measure the voltage of the connection between the back-to-back MOSFETS 210. The voltage of the connection between back-to-back MOSFETs 210 may be both the drain voltage of the first MOSFET (i.e., MOSFET Q1) and the drain voltage of the second MOSFET (i.e., MOSFET Q2). The difference between the source voltage and drain voltage of the first MOSFET (i.e., MOSFET Q1) may be continuously compared to a first predetermined voltage difference setpoint, and the ideal diode controller 201 may adjust a first gate drive DGate to regulate the voltage difference to the predetermined setpoint. The aforementioned voltage difference may also be compared to a second predetermined voltage setpoint (i.e., for reverse polarity protection). If the voltage difference is below the second predetermined voltage setpoint the ideal diode controller 201 may disable the first gate drive DGate. Disabling the first gate drive DGate may disconnect the reversed input battery. In this manner, damage to the ideal diode controller 201 or any components connected to Vout may be prevented.

The back-to-back MOSFETs can include a first MOSFET Q1 and a second MOSFET Q2. The first MOSFET Q1 can provide reverse polarity protection and reverse current protection to the circuit. The second MOSFET Q2 can provide over-voltage protection and load-disconnect functionality. In this manner, the battery (i.e., connection to V_{IN}) can be disconnected from the rest of the system (i.e., connected to V_{OUT}). During regular operation of the mobile robot, the back-to-back MOSFETs 210 are turned on. In this manner, the ideal diode control system 200 provides drastically reduced forward voltage drop and power dissipation as compared to a Schottky diode, which may preserve battery life for the mobile robot. Further, reverse current can flow into the battery during input supply failure or micro-short conditions, potentially damaging the battery and draining holdup capacitors in downstream systems. The ideal diode control system 200 can provide reverse recovery, for example by monitoring the voltage across the back-to-back MOSFETs 210 and turning off the back-to-back MOSFETs 210 during to prevent reverse current, for example by a strong pulldown current.

A voltage monitor 220 can be electrically coupled to the circuit. The voltage monitor 220 can be configured to determine a voltage of a battery connected to VIN, (i.e., a swappable battery and/or a fixed battery). The voltage monitor can be disposed electrically between the Vin and OverVoltage channels of the ideal diode controller 201.

A battery enable input 230 can be electrically coupled to the circuit. The battery enable input 230 can be configured to provide a battery toggle command, (i.e., to electrically connect or disconnect a battery from a mobile robot) to the ideal diode controller 201. In various embodiments, upon receiving a swap battery command, the battery enable input 230 may provide a battery toggle command to the ideal diode controller 201 to electrically disconnect a battery from a mobile robot, for example so that the battery may be swapped. In various embodiments, upon installation of a charged battery in the mobile robot, the battery enable input 230 may provide a battery toggle command to the ideal diode controller 201 to electrically connect a battery to the mobile robot, for example to provide electrical power for operation of the mobile robot.

FIG. 3 illustrates an exemplary power architecture 300 for a swappable battery system, in accordance with various embodiments. Power architecture 300 can include a first battery 310, a second battery 312, a first ideal diode controller 320, a second ideal diode controller 322, a first set of back-to-back MOSFETs 321, a second set of back-to-back MOSFETs 323, a hot swap controller 330, and a breaker input 332. The power architecture 300 may be included in a mobile robot 302. The first ideal diode controller 320 and the second ideal diode controller 322 can be the same or similar to the ideal diode controller 201, described above. The first set of back-to-back MOSFETs 321 and the second set of back-to-back MOSFETs 323 can be the same or similar to the back-to-back MOSFETs 210, described above.

The first battery 310 can be a swappable battery or a fixed battery. The second battery 312 can be a swappable battery or a fixed battery. In various embodiments, at least one of the first battery 310 and the second battery 312 is a swappable battery. In various embodiments, the first battery 310 and the second battery 312 are both swappable batteries. The first battery 310 may be electrically coupled to the first ideal diode controller 320 and/or to the first set of back-to-back MOSFETs 321. The second battery 312 may be electrically coupled to the second ideal diode controller 322 and/or to the second set of back-to-back MOSFETs 323. In this manner, the first battery 310 and the second battery 312 can be independently controlled (i.e., by the first ideal diode controller 320 and/or by the second ideal diode controller 322).

The hot swap controller 330 can include a Vcc channel and a Vout channel. The Vcc channel can be configured to provide an input voltage to the hot swap controller 330. The Vout channel can be configured to measure the output voltage of a power MOSFET 333. In this manner, a voltage drop across the power MOSFET 333 can be measured. The hot swap controller can include a (e.g., large) low-impedance shunt resistor 331 which may be disposed inline with the power architecture 300. The hot swap controller 330 can include a sense channel. The sense channel can be configured to measure a current flowing across the shunt resistor 331 and/or through the power MOSFET 333 (i.e., to the mobile robot 302). The hot swap controller 330 can include a gate channel configured to control a power MOSFET 333. The hot swap controller 330 can control the power MOSFET 333 to independently control (e.g., limit) the current and/or the power flowing through the power MOSFET 333 (i.e., to the mobile robot 302). The hot swap controller can include an enable channel configured to receive a power toggle command from a breaker input 332. The breaker input 332 can provide a power toggle command to the hot swap controller 330 to command the hot swap controller 330 to enable or disable power flowing through the power MOSFET 333 (i.e., to the mobile robot 302). Although illustrated with a single hot swap controller 330, multiple instances of the hot swap controller 330 may be connected in parallel to create individual current and/or power limit controllers for individual subsystems (e.g., a first hot swap controller 330 can limit power to the robot controller and a second hot swap controller 330 can limit power to a manipulator).

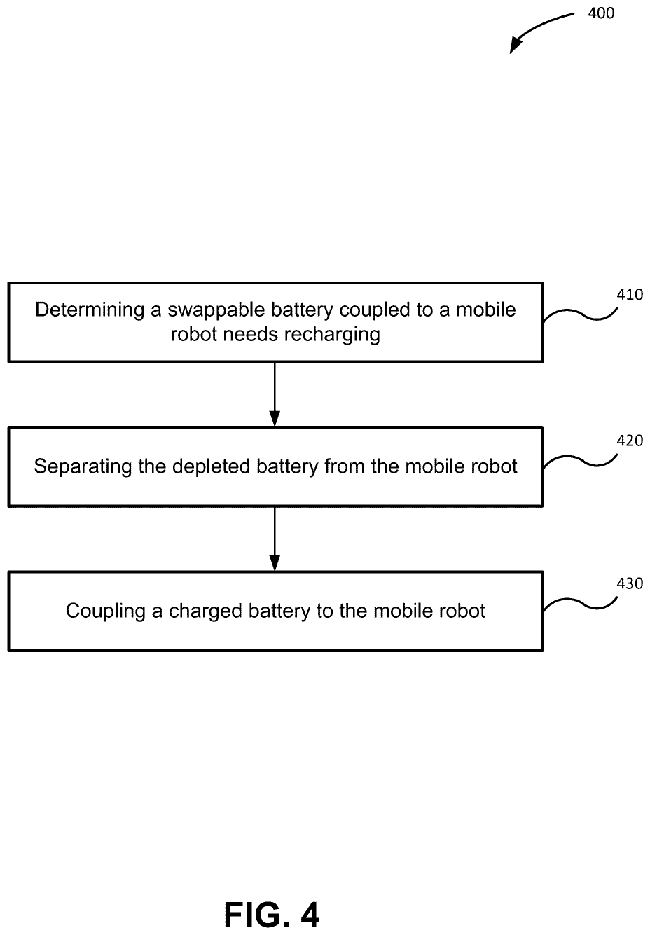

FIG. 4 illustrates a method 400 for swapping a battery in a mobile robot, in accordance with various embodiments. The method 400 can include determining a swappable battery coupled to a mobile robot needs to be recharged (step 410), separating the swappable battery from the mobile robot (step 420), and coupling a charged battery to the mobile robot (step 430).

At step 410, the determining can be performed by the mobile robot, an operator, a controller external to the mobile robot (i.e., a central controller), and/or by any other suitable system or mechanism. The determining may be based on a state of charge of the swappable battery. For example, when a state of charge of the swappable battery falls below a predetermined threshold, it may be determined that the swappable battery needs to be recharged.

At step 420, the separating the swappable battery from the mobile robot may be by any suitable method, for example, the separating may be performed by any method discussed above. The separating may be by a person, by an arm and/or manipulator of a charging station, by an arm and/or manipulator of the mobile robot, and/or by an arm or manipulator of another mobile robot. The swappable battery that is separated may be the swappable battery determined at step 410 to have a state of charge below the predetermined threshold.

At step 430, the coupling the charged battery to the mobile robot may be by any suitable method, for example, the coupling may be performed by any method discussed above. The coupling may be by a person, by an arm and/or manipulator of a charging station, by an arm and/or manipulator of the mobile robot, and/or by an arm or manipulator of another mobile robot. The charged battery may be a swappable battery. The charged battery may be decoupled from a charging station, for example by the arm and/or manipulator, prior to the coupling. The charged battery may have a state of charge above a predetermined threshold. The predetermined threshold may be the same as or different from the predetermined threshold discussed with respect to step 410.

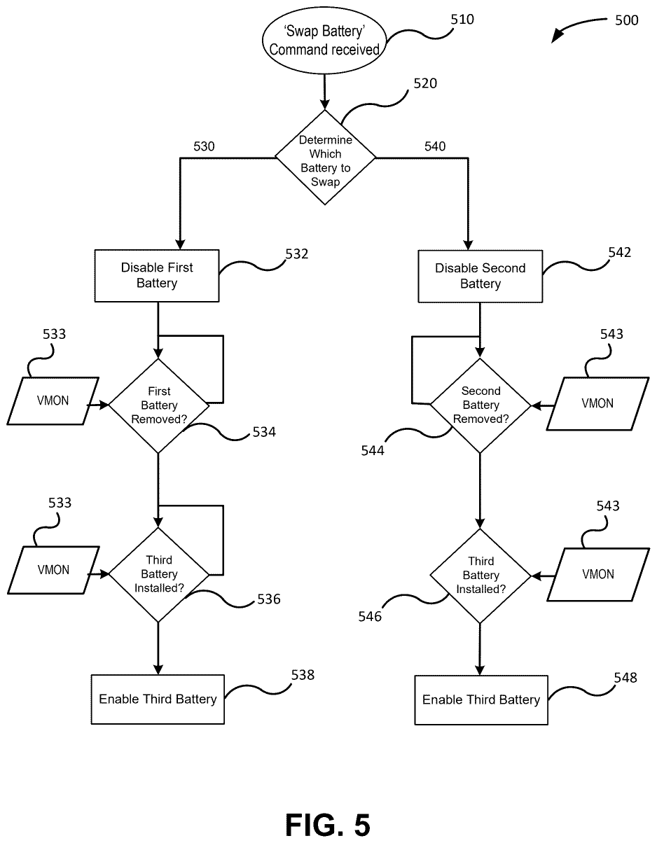

FIG. 5 illustrates a method 500 for swapping a battery in a mobile robot with two or more swappable batteries, in accordance with various embodiments. Method 500 can include a step 510 of receiving a swap battery command, a step 520 of determining which battery to swap, a path 530 including a step 532 of disabling a first battery, a step 534 of determining that the first battery has been removed, a step 536 of determining that a charged battery has been installed, and a step 538 of enabling the charged battery, a path 540 including a step 542 of disabling a second battery, a step 544 of determining that the second battery has been removed, a step 546 of determining that a charged battery has been installed, and a step 548 of enabling the charged battery.

At step 510, a swap battery command may be received at a mobile robot. For example, the swap battery command may be received at a controller of the mobile robot. The swap battery command may be issued by, for example, a controller of the mobile robot, an external control system, a charging station, or by any other suitable mechanism or process. The swap battery command may be issued based on a state of charge of a swappable battery of the mobile robot falling below a predetermined threshold.

At step 520, the mobile robot may determine which swappable battery should be swapped. In various embodiments, a swap battery command received at a controller of a mobile robot may indicate which swappable battery to swap. For example, when a voltage reading from voltage monitor 533 is below a predetermined threshold, the corresponding swap battery command may indicate that the first swappable battery should be swapped. If, at step 520, it is determined that a first swappable battery should be swapped, method 500 may proceed along path 530. If, at step 520, it is determined that a second swappable battery should be swapped, method 500 may proceed along path 540.

At step 532, a first swappable battery may be disabled. For example, the first swappable battery may be disabled by a first ideal diode controller. In this manner, the first swappable battery is disengaged from the system, and downstream power may remain undisturbed from any transient effects during a swapping of the first swappable battery.

At step 534, the mobile robot may determine whether the first swappable battery has been removed from the mobile robot. The mobile robot may determine whether the first swappable battery has been removed from the mobile robot based on a voltage reading of the first swappable battery. The voltage reading of the first swappable battery may be received from a voltage monitor 533. When the voltage reading from voltage monitor 533 is above a predetermined threshold, the mobile robot may determine that the first swappable battery has not been removed from the mobile robot, and may loop back to a beginning of step 534. When the voltage reading from voltage monitor 533 is below a predetermined threshold, the mobile robot may determine that the first swappable battery has been removed from the mobile robot. After determining that the first swappable battery has been removed from the mobile robot, method 500 may proceed to step 536.

At step 536, the mobile robot may determine whether a third swappable battery has been installed in the mobile robot. For example, the third swappable battery may be installed in the place of the first swappable battery after the first swappable battery has been removed. In this manner, a charged battery (i.e., the third swappable battery) may replace a depleted battery (i.e., the first swappable battery). The mobile robot may determine whether the third swappable battery has been installed in the mobile robot based on a voltage reading of the third swappable battery. The voltage reading of the third swappable battery may be received from the voltage monitor 533. When the voltage reading from voltage monitor 533 is below a predetermined threshold, the mobile robot may determine that the third swappable battery has not been installed in the mobile robot, and may loop back to a beginning of step 536. When the voltage reading from voltage monitor 533 is above a predetermined threshold, the mobile robot may determine that the third swappable battery has been installed in the mobile robot. After determining that the third swappable battery has been installed in the mobile robot, method 500 may proceed to step 538.

At step 538, the third swappable battery may be enabled. For example, the third swappable battery may be enabled by the first ideal diode controller. In this manner, the third swappable battery may provide electrical power for operation of the mobile robot. During path 530, a second swappable battery may continue to provide electrical power for operation of the mobile robot (i.e., during the battery swap of the first swappable battery). In this manner, fluctuations on the downstream power may be minimized and the mobile robot may continue operation without powering off during a battery swap.

At step 542, the second swappable battery may be disabled. For example, the second swappable battery may be disabled by a second ideal diode controller. In this manner, the second swappable battery is disengaged from the system, and downstream power may remain undisturbed from any transient effects during a swapping of the second swappable battery.

At step 544, the mobile robot may determine whether the second swappable battery has been removed from the mobile robot. The mobile robot may determine whether the second swappable battery has been removed from the mobile robot based on a voltage reading of the second swappable battery. The voltage reading of the second swappable battery may be received from a voltage monitor 543. When the voltage reading from voltage monitor 543 is above a predetermined threshold, the mobile robot may determine that the second swappable battery has not been removed from the mobile robot, and may loop back to a beginning of step 544. When the voltage reading from voltage monitor 543 is below a predetermined threshold, the mobile robot may determine that the second swappable battery has been removed from the mobile robot. After determining that the second swappable battery has been removed from the mobile robot, method 500 may proceed to step 546.

At step 546, the mobile robot may determine whether a third swappable battery has been installed in the mobile robot. For example, the third swappable battery may be installed in the place of the second swappable battery after the second swappable battery has been removed. In this manner, a charged battery (i.e., the third swappable battery) may replace a depleted battery (i.e., the second swappable battery). The mobile robot may determine whether the third swappable battery has been installed in the mobile robot based on a voltage reading of the third swappable battery. The voltage reading of the third swappable battery may be received from the voltage monitor 543. When the voltage reading from voltage monitor 543 is below a predetermined threshold, the mobile robot may determine that the third swappable battery has not been installed in the mobile robot, and may loop back to a beginning of step 546. When the voltage reading from voltage monitor 543 is above a predetermined threshold, the mobile robot may determine that the third swappable battery has been installed in the mobile robot. After determining that the third swappable battery has been installed in the mobile robot, method 500 may proceed to step 548.

At step 548, the third swappable battery may be enabled. For example, the third swappable battery may be enabled by the second ideal diode controller. In this manner, the third swappable battery may provide electrical power for operation of the mobile robot. During path 540, the first swappable battery may continue to provide electrical power for operation of the mobile robot (i.e., during the battery swap of the second swappable battery). In this manner, fluctuations on the downstream power may be minimized and the mobile robot may continue operation without powering off during a battery swap.

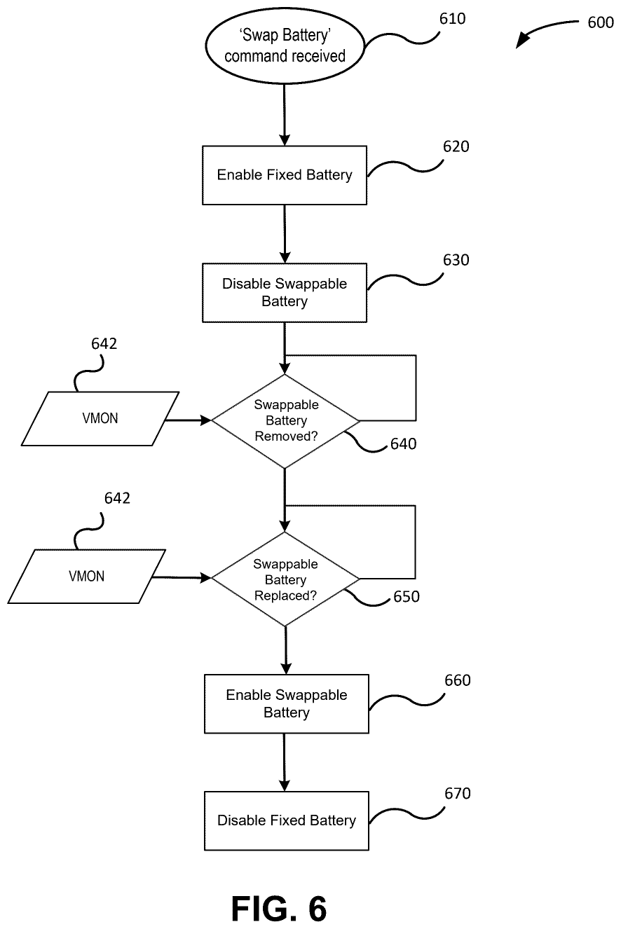

FIG. 6 illustrates a method 600 for swapping a battery in a mobile robot with a fixed battery, in accordance with various embodiments. Method 600 can include a step 610 of receiving a swap battery command, a step 620 of enabling a fixed battery, a step 630 of disabling a swappable battery, a step 640 of determining that the swappable battery has been removed, a step 650 of determining that a charged battery has been installed, a step 660 of enabling the charged battery, and a step 670 of disabling the fixed battery.

At step 610, a swap battery command may be received at a mobile robot. For example, the swap battery command be received at an ideal diode controller of a mobile robot or a controller of the mobile robot. The swap battery command may be issued by, for example, a controller of the mobile robot, an external control system, a charging station, or by any other suitable mechanism or process. The swap battery command may be issued based on a state of charge of a swappable battery of the mobile robot falling below a predetermined threshold.

At step 620, a fixed battery may be enabled. For example, the fixed battery may be enabled by a first ideal diode controller. In this manner, the fixed battery may provide electrical power for operation of the mobile robot (i.e., during the battery swap of the swappable battery). In this manner, fluctuations on the downstream power may be minimized and the mobile robot may continue operation without powering off during a battery swap.

At step 630, a swappable battery may be disabled. For example, the swappable battery may be disabled by a second ideal diode controller. In this manner, the swappable battery is disengaged from the system, and downstream power may remain undisturbed from any transient effects during a swapping of the swappable battery.

At step 640, the mobile robot may determine whether the swappable battery has been removed from the mobile robot. The mobile robot may determine whether the swappable battery has been removed from the mobile robot based on a voltage reading of the swappable battery. The voltage reading of the swappable battery may be received from a voltage monitor 642. When the voltage reading from voltage monitor 642 is above a predetermined threshold, the mobile robot may determine that the swappable battery has not been removed from the mobile robot, and may loop back to a beginning of step 640. When the voltage reading from voltage monitor 642 is below a predetermined threshold, the mobile robot may determine that the swappable battery has been removed from the mobile robot. After determining that the swappable battery has been removed from the mobile robot, method 600 may proceed to step 650.

At step 650, the mobile robot may determine whether the swappable battery has been replaced (i.e., whether a charged swappable battery has been installed in the mobile robot). For example, the charged swappable battery may be installed in the place of the depleted swappable battery after the depleted swappable battery has been removed. The mobile robot may determine whether the charged swappable battery has been installed in the mobile robot based on a voltage reading of the charged swappable battery. The voltage reading of the charged swappable battery may be received from the voltage monitor 642. When the voltage reading from voltage monitor 642 is below a predetermined threshold, the mobile robot may determine that the charged swappable battery has not been installed in the mobile robot, and may loop back to a beginning of step 650. When the voltage reading from voltage monitor 642 is above a predetermined threshold, the mobile robot may determine that the charged swappable battery has been installed in the mobile robot. After determining that the charged swappable battery has been installed in the mobile robot, method 600 may proceed to step 660.

At step 660, the charged swappable battery may be enabled. For example, the charged swappable battery may be enabled by the second ideal diode controller. In this manner, the charged swappable battery may provide electrical power for operation of the mobile robot. During the battery swap of the swappable batteries, the fixed battery may continue to provide electrical power for operation of the mobile robot. In this manner, fluctuations on the downstream power may be minimized and the mobile robot may continue operation without powering off during the battery swap.

At step 670, the fixed battery may be disabled. For example, the fixed battery may be disabled by the first ideal diode controller. In this manner, the fixed battery is disengaged from the system, and the state of charge of the fixed battery may be maintained. Optionally, the fixed battery may be charged by the charged swappable battery. In this manner, the state of charge of the fixed battery may be increased without decoupling the fixed battery from the mobile robot or coupling the mobile robot to a charging cable. For example, the fixed battery may be charged by the charged swappable battery to above a predetermined threshold. The predetermined threshold may be sufficient to power the mobile robot during at least one battery swap operation.

While the foregoing discussion utilizes batteries as exemplary power-providing units, it will be appreciated that the principles disclosed herein may be applied to other modular power-providing units, such as supercapacitors, fuel cells, or the like.

Any of the systems and methods disclosed herein may be implemented with varying combinations of hardware, software, communications and/or networking interfaces, machine learning or similar algorithms, and various mechanical and/or electrical machinery including actuators, electric motors, pneumatic devices, mechanical joints, batteries, couplings, linkages, fuel cells, imaging sensors, radar, LIDAR, pressure sensors, and/or the like.

Computer programs (also referred to as computer control logic) are stored in main memory and/or secondary memory. Computer programs may also be received via communications interface. These computer program instructions may be loaded onto a general-purpose computer, special purpose computer, controller, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer, controller, or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor or controller, causes the processor or controller to perform the functions of various embodiments as described herein. In various embodiments, hardware components may take the form of application specific integrated circuits (ASICs), general-purpose microprocessors, and/or the like. Implementation of the hardware so as to perform the functions described herein will be apparent to persons skilled in the relevant art(s).

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A mobile robot having a swappable battery, comprising:
a robot body having at least one component for movement of the mobile robot;
a manipulator configured to manipulate an environment external to the mobile robot;
one or more swappable batteries releasably coupled to the mobile robot, the one or more swappable batteries configured to provide electrical power for operation of the mobile robot; and
one or more non-transitory memories storing computing instructions configured to communicate with one or more processors and cause the one or more processors to:
move the mobile robot by the component for movement of the mobile robot; and
manipulate, by the manipulator, the one or more swappable batteries.

2. The mobile robot of claim 1, wherein the mobile robot comprises two or more batteries, at least one of the two or more batteries being of the one or more swappable batteries.

3. The mobile robot of claim 2, wherein at least one of the two or more batteries is a fixed battery.

4. The mobile robot of claim 2, further comprising a first ideal diode controller electrically coupled between a first of the two or more batteries and at least one of the component for movement of the mobile robot, the manipulator, and the one or more processors.

5. The mobile robot of claim 4, further comprising a second ideal diode controller electrically coupled between a second of the two or more batteries and at least one of the component for movement of the mobile robot, the manipulator, and the one or more processors.

6. The mobile robot of claim 5, further comprising a hot-swap controller electrically coupled between each of the first ideal diode controller and the second ideal diode controller and at least one of the component for movement of the mobile robot, the manipulator, and the one or more processors.

7. The mobile robot of claim 1, wherein the component for movement comprises a plurality of legs, a plurality of wheels, or a combination thereof.

8. The mobile robot of claim 1, wherein the manipulator comprises a robotic arm.

9. The mobile robot of claim 8, wherein the robotic arm comprises a grasping apparatus configured to grasp a depleted battery from the one or more swappable batteries, and wherein the robotic arm is operable to decouple the depleted battery from the mobile robot.

10. The mobile robot of claim 8, the one or more non-transitory memories storing further computing instructions configured to communicate with the one or more processors and further cause the one or more processors to cause the robotic arm to:
decouple a depleted battery from the mobile robot;
grasp a charged battery an external environment; and
couple the charged battery to the mobile robot, the charged battery configured to provide electrical power for operation of the mobile robot.

11. A system for mobile robots having swappable batteries, comprising:
one or more mobile robots, each of the one or more mobile robots comprising:
a robot body having at least one component for movement of the mobile robot;
one or more swappable batteries releasably coupled to the mobile robot, the swappable batteries configured to provide electrical power for operation of the mobile robot; and
one or more non-transitory memories storing computing instructions configured to communicate with one or more processors and cause the one or more processors to:
move the mobile robot by the component for movement of the mobile robot; and
a charging station configured to charge the one or more swappable batteries, the charging station comprising a manipulator configured to manipulate the one or more swappable batteries.

12. The system of claim 11, the manipulator configured to decouple a depleted battery of the one or more swappable batteries from a mobile robot of the one or more mobile robots and to couple the depleted battery to the charging station to recharge the depleted battery.

13. The system of claim 11, the manipulator configured to decouple a charged battery from the charging station and to couple the charged battery to a mobile robot of the one or more mobile robots, the charged battery configured to provide electrical power for operation of the mobile robot.

14. A method of hot-swapping one or more swappable batteries for a mobile robot comprising two or more batteries, the method comprising:
electrically disconnecting, by a first ideal diode controller, a first of the two or more batteries from the mobile robot;
maintaining, by a second ideal diode controller, an electrical connection between a second of the two or more batteries and the mobile robot;
decoupling, by a manipulator, the first of the two or more batteries from the mobile robot;
coupling, by the manipulator, a third battery to the mobile robot; and
electrically connecting, by the first ideal diode controller, the third battery to the mobile robot.

15. The method of claim 14, wherein the first of the two or more batteries and the second of the two or more batteries are swappable.

16. The method of claim 15, further comprising detecting, by the mobile robot, that the first of the two or more batteries is below a threshold state of charge.

17. The method of claim 14, further comprising detecting, by the mobile robot, that a voltage received from the third battery is above a threshold level, wherein the detecting is after the step of coupling the third battery to the mobile robot and before the step of electrically connecting the third battery to the mobile robot.

18. The method of claim 14, wherein the second of the two or more batteries is a fixed battery.

19. The method of claim 18, further comprising electrically connecting, by the second ideal diode controller, the second of the two or more batteries to the mobile robot before electrically disconnecting the first of the two or more batteries from the mobile robot.

20. The method of claim 19, further comprising:
electrically disconnecting, by the second ideal diode controller, the second of the two or more batteries from the mobile robot after electrically connecting the third battery to the mobile robot; and
recharging, by the third battery, the second of the two or more batteries.
